(19) United States
(12) Patent Application Publication
(10) Pub. No.: US 2025/0156644 A1
(43) Pub. Date: May 15, 2025

(54) SYNTHETIC DATA GENERATION USING LARGE LANGUAGE MODELS

(71) Applicant: NVIDIA Corporation, Santa Clara, CA (US)

(72) Inventors: Chandana NEERUKONDA, Santa Clara, CA (US); Rajath SHETTY, Sunnyvale, CA (US); Felipe SOARES, Perpignan (FR); Makesh Narsimhan SREEDHAR, Madison, WI (US)

(21) Appl. No.: 18/505,739

(22) Filed: Nov. 9, 2023

(51) Int. Cl. G06F 40/35; G06F 40/289; G06N 3/0455

(52) U.S. Cl. CPC G06F 40/35; G06F 40/289; G06N 3/0455

(57) ABSTRACT

In various examples, synthetic question-answer (QA) pairs may be generated using question and answer generation models comprising corresponding language models (e.g., autoregressive LLMs). A repository of textual data representing a particular knowledge base may be used to source synthetic QA pairs by partitioning textual data from the repository into units of text (e.g., paragraphs) that represent context. For each unit of text, the question generation model may be prompted to generate a synthetic question from that unit of text, and the answer generation model may be prompted to generate a synthetic answer to the synthetic question. Textual entailment and/or human evaluations may be used to filter out low quality, incorrect, and/or non-productive QA pairs that may be a result of hallucinations. As such, the synthetic QA pairs may be used as, and/or may be used to generate, training data for one or more machine learning models.

### BACKGROUND

Question-answer (QA) pairs may be used to train and evaluate models for tasks such as those involved in generating and understanding human language. QA pairs typically include some form of a question (e.g., in the form of a sentence, a phrase, or any text that prompts an answer) and an answer (e.g., the corresponding response or piece of information that provides a solution, explanation, and/or description in response to the question, and which may take the form of text, numbers, images, tables, and/or other types of responsive data). QA pairs may be used in machine learning applications such as question answering systems, information retrieval systems, chatbots, and virtual assistants. QA pairs are typically used for supervised learning, where models may be trained using a dataset of QA pairs to map questions to their corresponding answers. The creation and curation of high-quality QA datasets is often crucial for training and evaluating machine learning models effectively in natural language processing tasks.

Machine learning models are often tailored to a particular domain. For example, since different domains (e.g., healthcare, finance, medical, legal) have their own unique characteristics, terminologies, and patterns, fine-tuning allows models to capture and leverage domain-specific knowledge, making them more effective in understanding and generating data within that domain. As such, high-quality QA datasets that are tailored to a particular domain or knowledge base are often desired, but unavailable. Manual and/or crowdsourced efforts are often employed to generate these datasets, ensuring that they cover the desired language patterns and topics. However, manually generating and/or crowdsourcing such datasets can be both challenging and time-consuming, depending on the complexity of the desired data and the scale of the dataset. For example, manually annotating thousands or millions of data points is typically impractical, resource intensive, and time-consuming. Furthermore, maintaining consistency and accuracy in manually generated datasets can be difficult, which can result in lower quality datasets that negatively impact the accuracy and/or bias of the resulting models. One current technique uses large language models (LLMs) such as ChatGPT or other generative pre-trained transformer (GPT) LLMs to generate QA pairs by applying a single prompt that includes multiple (few-shot) examples. However, the quality of the QA pairs that are generated from a single prompt is limited, as the generated questions often look similar to one another, and the generated answers often include samples from the examples that were provided in the prompt. As such, there is a need for improved techniques for generating higher quality QA pairs in a desired domain.

### SUMMARY

Embodiments of the present disclosure relate to synthetic data generation using large language models. Systems and methods are disclosed that generate synthetic QA pairs using question and answer generation models (e.g., autoregressive LLMs).

In contrast to conventional systems, such as those described above, a repository of textual data representing a particular knowledge base (e.g., scientific articles, product or industrial manuals, call center logs, etc.) may be used to source synthetic QA pairs by chunking, partitioning, extracting, or otherwise identifying textual data from the repository to generate corresponding units of text (e.g., paragraphs) that represent context. For each unit of text, the question generation model may be prompted to generate a synthetic question from that unit of text, and the answer generation model may be prompted to generate a synthetic answer to the synthetic question. Textual entailment and/or human evaluations may be used to filter out low quality, incorrect, and/or non-productive QA pairs that may be a result of hallucinations. As such, the synthetic QA pairs may be used as, and/or may be used to generate, training data for one or more machine learning models such as those used in question answering systems, information retrieval systems, chatbots and virtual assistants, summarizers, textual entailment systems, machine translation evaluation systems, and/or other types of systems or applications.

### BRIEF DESCRIPTION OF THE DRAWINGS

The present systems and methods for synthetic data generation using large language models are described in detail below with reference to the attached drawing figures, wherein:

FIG. 1 is a data flow diagram illustrating an example synthetic data generation system, in accordance with some embodiments of the present disclosure;

FIG. 2 is a data flow diagram illustrating an example question and answer model generation system, in accordance with some embodiments of the present disclosure;

FIG. 3 is a data flow diagram illustrating an example filtering system, in accordance with some embodiments of the present disclosure;

FIG. 4 is a flow diagram showing a method for generating a synthetic question and answer, in accordance with some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed relating to synthetic data generation using large language models (LLMs). For example, systems and methods are disclosed that generate synthetic QA pairs using question and answer generation models (e.g., autoregressive LLMs). A repository of textual data representing a particular knowledge base (e.g., scientific articles, product or industrial manuals, call center logs, etc.) may be used to source synthetic QA pairs by chunking, partitioning, extracting, or otherwise identifying textual data from the repository to generate corresponding units of text (e.g., paragraphs) that represent context. For each unit of text, the question generation model may be prompted to generate a synthetic question from that unit of text, and the answer generation model may be prompted to generate a synthetic answer to the synthetic question. Textual entailment and/or human evaluations may be used to filter out low quality, incorrect, and/or non-productive QA pairs that may be a result of hallucinations. As such, the synthetic QA pairs may be used as, and/or may be used to generate, training data for one or more machine learning models such as those used in question answering systems, information retrieval systems, chatbots and virtual assistants, summarizers, textual entailment systems, machine translation evaluation systems, and/or other types of systems or applications.

In some embodiments, question and/or answer generation models may be generated by updating, tuning, or otherwise adapting a base LLM (e.g., an autoregressive LLM) using an existing QA dataset to tailor the base LLM to the question and/or answer generation tasks. For example, the base LLM may be tuned or otherwise adapted to the question and/or answer generation tasks using fine-tuning (e.g., freezing one or more layers of a pre-trained model), Parameter-Efficient Fine-Tuning (PEFT) (e.g., Low-Rank Adaptation (LoRA), prefix tuning, prompt tuning, p-tuning), some other technique that updates one or more trainable parameters (e.g., network weights, rank decomposition matrices, hard prompts, soft prompts), and/or otherwise. For example, p-tuning may involve adding one or more layers to an input of the base LLM and training that resulting model (e.g., fixing one or more pre-trained layers of the base LLM) using the existing QA dataset to learn corresponding weights for the added layer(s). The QA dataset used to tune the base model may include a general purpose QA dataset and/or (e.g., manually generated) QA pairs focusing on a particular domain, which should improve the performance of the tuned models in that domain. As such, a question generation model may be generated by tuning the base model for the question generation task, and/or an answer generation model may be generated by tuning the base model for the answer generation task.

The question and answer generation models may be used to generate synthetic QA pairs focusing on any desired domain, knowledge base, and/or other use case (whether general purpose or specific). Taking an example embodiment in which a particular knowledge base is represented in a repository of scientific articles, the articles may be partitioned into units of text (e.g., strings, words, sentences, paragraphs, etc.) that represent different contexts from the knowledge base. Each unit of text may be used to source a corresponding synthetic question and synthetic answer. For example, taking an extracted paragraph as an example, a prompt such as “Please generate a question from the following paragraph: [extracted paragraph]” may be applied to the question generation model to generate a synthetic question based on the context represented by that paragraph, and a prompt such as “Please answer this question based on the following paragraph: [synthetic question][extracted paragraph]” may be applied to the answer generation model to generate a synthetic answer to the synthetic question based on the context represented by that paragraph. In some embodiments, the synthetic QA pair may be associated with the corresponding unit of text used to source the synthesized QA pair to form a (question, answer, context) (Q,A,C) triplet. The process may be repeated to generate any number of synthetic QA pairs and/or (Q,A,C) triplets.

In some embodiments, filtering is applied to filter out low quality, incorrect, and/or non-productive synthetic QA pairs and/or (Q,A,C) triplets that may be a result of or otherwise represent hallucinations. For example, entailment may be used to predict whether a synthetic question can be answered from the corresponding source unit of text and/or whether a synthetic answer was actually extracted from the corresponding source unit of text. For example, an entailment filter (e.g., LLM such as an autoregressive LLM tuned for question entailment) may be used to predict whether a synthetic question can be answered from the corresponding source unit of text using zero-, one-, and/or few-shot inference (e.g., applying a prompt that includes one or more positive and/or negative examples of question entailment). Additionally or alternatively, an entailment filter (e.g., an LLM such as an autoregressive LLM tuned for answer entailment) may be used to predict whether a synthetic answer was actually extracted from the corresponding source unit of text using zero-, one-, and/or few-shot inference (e.g., applying a prompt that includes one or more positive and/or negative examples of answer entailment). As such, synthetic QA pairs and/or (Q,A,C) triplets that are predicted not to represent an entailed question and/or an entailed answer may be removed from the resulting dataset. Additionally or alternatively, one or more human evaluations may be performed to identify and remove synthetic QA pairs and/or (Q,A,C) triplets that represent low quality, incorrect, and/or non-productive data based on one or more pre-defined metrics (e.g., entailment, utility, etc.).

As such, the resulting synthetic QA dataset may be used as, and/or may be used to generate, training data to train and/or tune one or more machine learning models (e.g., those used in question answering systems, information retrieval systems, chatbots and virtual assistants, summarizers, textual entailment systems, machine translation evaluation systems, and/or other types of systems or applications).

Taking information retrieval from a repository (e.g., that was used to generate the synthetic QA dataset) as an example, each document or other text in the repository may be partitioned into some number of chunks, and each chunk may be encoded into a semantic embedding. A retriever model may be used to encode a particular query into a corresponding semantic embedding and retrieve one of the chunks based on a measure of similarity between the semantic embeddings of the query and the chunk. A synthetic QA pair and/or triplet may be used to train (e.g., fine-tune) the retrieval model using the synthetic question as an example query and using the synthetic answer and/or corresponding source context as corresponding ground truth (e.g., backpropagating a representation of the difference between semantic embeddings of the chunk retrieved by the retrieval model on the one hand, and the ground truth answer and/or source context from a synthetic QA triplet on the other).

Taking question answering based on information retrieval from a repository as an example, a question answering model may take a retrieved chunk (e.g., retrieved by a retrieval model) and generate a corresponding answer from the retrieved chunk and the query. A synthetic QA pair and/or triplet may be used to train (e.g., fine-tune) the question answering model, for example, by applying a synthetic question on the one hand and the corresponding source context from a synthetic QA triplet (or a synthetic question and a retrieved chunk retrieved by a retriever model) to the question answering model to generate an answer, and using the synthetic answer as ground truth (e.g., backpropagating a representation of the difference between semantic embeddings of the generated answer and the synthetic answer from the synthetic QA pair and/or triplet).

Taking reranking as another example, a reranker model may retrieve a plurality of chunks based on semantic similarity to the query and rerank the retrieved chunks to promote the most relevant chunks to the top of a list of search results. Taking a plurality of synthetic QA triplets as an example, one of the triplets may be used as a positive example of a query (the synthetic question) and a ground truth highly re-ranked chunk (e.g., the corresponding synthetic answer and/or source context for the synthetic question), and one or more other synthetic QA triplets (e.g., a synthetic answer and/or the corresponding source context) may be used as negative example(s) of ground truth lower re-ranked chunk(s). These are just a few examples, and others are contemplated within the scope of the present disclosure.

As such, the techniques described herein may be utilized to generate synthetic training data and/or to train or update (e.g., tune) one or more machine learning models using the synthetic training data. Accordingly, synthetic training data may be generated to tune a machine learning model for any desired domain, knowledge base, and/or other use case, avoiding the impractical, resource intensive, and time-consuming process involved in manually generating a dataset. Furthermore, the present techniques should substantially improve the quality of synthetic training data over prior techniques such as those that apply a single prompt to generate multiple data points (e.g., QA pairs).

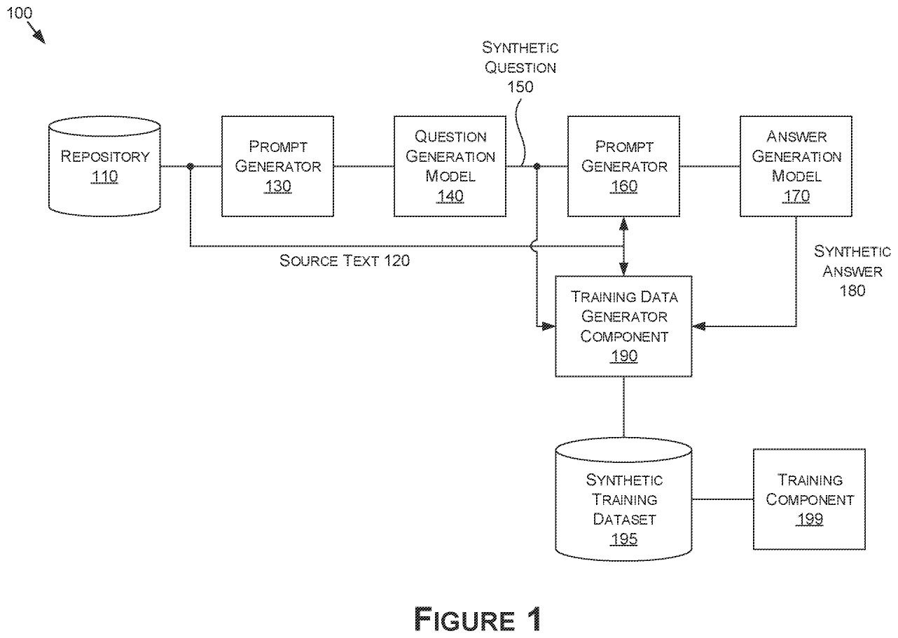

With reference to FIG. 1, FIG. 1 is an example synthetic data generation system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

In the embodiment illustrated in FIG. 1, the synthetic data generation system 100 includes a repository 110, a prompt generator 130, a question generation model 140, a prompt generator 160, an answer generation model 170, a training data generation component 190, a synthetic training dataset 195, and a training component 199. At a high level, the repository 110 may store textual data representing a particular knowledge base (e.g., a collection of one or more scientific articles, product or industrial manuals, call center logs, etc.), and the synthetic data generation system 100 may use the repository 110 to generate synthetic questions (e.g., synthetic question 150) and synthetic answers (e.g., synthetic answer 180) covering the subject matter of the knowledge base represented by the repository 110. In some embodiment, the training data generation component 190 may associate the synthetic question 150, the synthetic answer 180, and/or the source text 120 and include them in the synthetic training dataset 195. Additionally or alternatively, the training data generation component 190 may derive some input training and/or corresponding ground truth training data from the synthetic question 150, the synthetic answer 180, and/or the source text 120, and may include the input and ground truth training data in the synthetic training dataset 195. As such, the training component 199 may use the synthetic training dataset 195 to train, update, tune, or otherwise adapt one or more machine learning models to the subject matter of the knowledge base represented by the repository 110.

For example, assume a manufacturer of some product wants to provide customers with access to a question answering system that can answer questions about its product. In another example, assume a company or university wants to provide researchers with access to a question answering system that can answer questions about highly technical scientific or research topics, or provide access to a retrieval system that can identify relevant passages from a database of technical content. Currently available language models will not typically perform well and can even fail in niche or highly technical domains, and there are often scenarios where there is no training data representing the subject matter of the desired use case that can be used to fine-tune an available language model for that use case.

As such, textual data representing the desired use case may be collected and stored in the repository 110 in any suitable form (e.g., one or more files, relational databases, document databases, content or document management systems, in-memory databases, cloud storage, etc.). For example, the repository 110 may store a collection of textual data representing some domain-specific knowledge base (e.g., product information, product catalog(s), troubleshooting guide(s), customer support records such as call logs, news article(s), scientific research, scientific or chemical database(s), medical or healthcare-related information, legal information (e.g., legal statutes, case law, legal precedents), geographic information (e.g., maps), financial or economic information, literary information, lexical database(s), some particular topic(s) in one or more of the foregoing categories, etc.).

In some embodiments, the textual data may be partitioned into units of text (e.g., strings, words, sentences, paragraphs, some other chunk of text, etc.) that represent a corresponding unit of context from the knowledge base represented by the repository 110, and the partitioned units of text may be stored in, or otherwise identified by, the repository 110. In some embodiments, units of text may be sized according to the capacity of the question generation model 140 and/or the answer generation model 170. For example, the question generation model 140 and/or the answer generation model 170 may have some input token limit (e.g., 4096 tokens), so the textual data may be partitioned into units of text no greater than the input token limit (or some lower token limit allocated to the unit of text when including it as part of a prompt). In some embodiments, the units of text may be partitioned at semantically meaningful locations, such as at the ends of sentences or paragraphs. In some embodiments, textual data may be extracted from any type or form or structure (e.g., one or more files), the extracted textual data may be partitioned into units, and the units of textual data may be stored or identified in any type of form or structure (e.g., a table or some other structured format). These are just a few examples, and any known technique for chunking, partitioning, extracting, or otherwise identifying units of textual data may be performed.

The prompt generator 130 and/or the prompt generator 160 may retrieve, access, extract, or otherwise identify a unit of text from the repository 110 and use it as source text 120 to generate the synthetic question 150 and/or the synthetic answer 180, for example, by including it in a prompt for the question generation model 140 and/or the answer generation model 170. In some embodiments, for each unit of text stored in or otherwise identified by the repository 110, the prompt generator 130 may retrieve the unit of text and use it as source text 120 to generate and apply a corresponding prompt or other representation of the source text 120 and/or a corresponding instruction to the question generation model 140 to generate the synthetic question 150. Additionally or alternatively, for each unit of text stored in or otherwise identified by the repository 110, the prompt generator 160 may use the synthetic question 150 generated by the question generation model 140 and/or the source text 120 to generate and apply a corresponding prompt or other representation of the source text 120 and/or a corresponding instruction to the answer generation model 170 to generate the synthetic answer 180.

The type of prompt generated and applied by the prompt generator 130 may depend on the type of model implemented by the question generation model 140, and the type of prompt generated and applied by the prompt generator 160 may depend on the type of model implemented by the answer generation model 170. By way of non-limiting example, in some embodiments in which the question generation model 140 and/or the answer generation model 170 are implemented using a corresponding language model that accepts freeform input text, and in which the source text 120 can be characterized as a paragraph (whether or not it originally appeared in paragraph form in the repository 110), the prompt generator 130 may generate a prompt such as “Please generate a question from the following paragraph: [source text 120],” where the prompt generator 130 may insert the source text 120 between the brackets and apply the resulting prompt to the question generation model 140 to generate the synthetic question 150 based on the context represented by the source text 120. Continuing with this example, the prompt generator 160 may generate a prompt such as “Please answer this question based on the following paragraph: [synthetic question 150][source text 120],” where the prompt generator 160 may insert the synthetic question 150 and the source text 120 between corresponding sets of brackets and apply the resulting prompt to the answer generation model 170 to generate the synthetic answer 180 to the synthetic question 150 based on the context represented by the source text 120. This is meant simply as an example, and other prompts may be used, such as hard prompts and/or soft prompts instructing a corresponding model to generate or synthesize a question and/or answer based on the source text 120.

The question generation model 140 and/or the answer generation model 170 may be implemented using a DNN, such as a convolutional neural network (CNN). Although certain embodiments are described with the question generation model 140 and/or the answer generation model 170 being implemented using neural network(s), this is not intended to be limiting. For example, and without limitation, the question generation model 140, the answer generation model 170, and/or other models described herein may include any type of a number of different networks or machine learning models, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, transformer, recurrent, perceptrons, Long/Short Term Memory (LSTM), Hopfield, Boltzmann, deep belief, de-convolutional, generative adversarial, liquid state machine, etc.), and/or other types of machine learning models.

In an example embodiment, the question generation model 140 and/or the answer generation model 170 are each implemented using a language model with a transformer architecture comprising one or more layers of self-attention mechanisms and/or feedforward neural networks. For example, the language model may be an autoregressive language model (e.g., a GPT LLM such as NeMo Megatron-GTP or ChatGPT, Bidirectional and Auto-Regressive Transformers (BART), etc.), an autoencoding language model (e.g., Bidirectional Encoder Representations from Transformers (BERT)), or some combination thereof. In some embodiments, the question generation model 140 and/or the answer generation model 170 comprise a corresponding pretrained (e.g., autoregressive language) model, which may be tuned or otherwise adapted to the question and/or answer generation tasks using fine-tuning (e.g., freezing one or more layers of the pre-trained model), Parameter-Efficient Fine-Tuning (PEFT) (e.g., Low-Rank Adaptation (LoRA), prefix tuning, prompt tuning, p-tuning), some other technique that updates one or more trainable parameters (e.g., network weights, rank decomposition matrices, hard prompts, soft prompts), and/or otherwise.

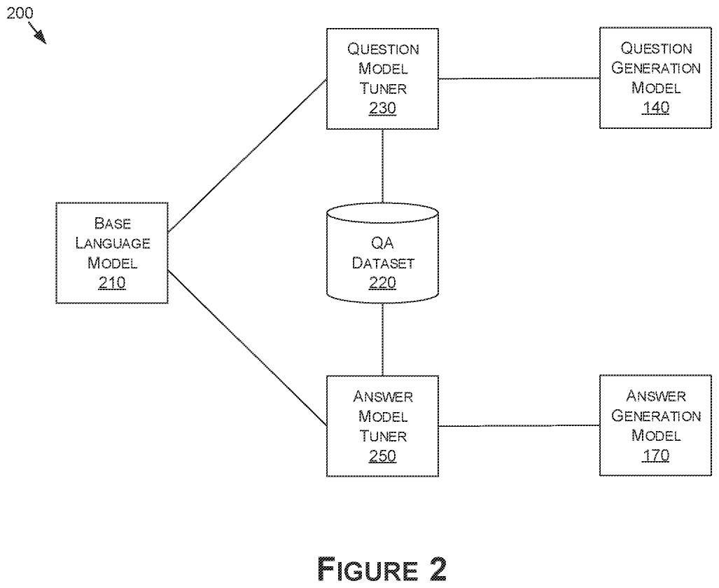

FIG. 2 is a data flow diagram illustrating an example question and answer model generation system 200, in accordance with some embodiments of the present disclosure. The question and answer model generation system 200 represents an example technique that may be used to generate or update the question generation model 140 and/or the answer generation model 170, for example, by tuning or otherwise adapting the question generation model 140 and/or the answer generation model 170 to the question and/or answer generation tasks. In the embodiment illustrated in FIG. 2, the question and answer model generation system 200 includes a base language model 210, a QA dataset 220, a question model tuner 230, the question generation model 140, an answer model tuner 250, and the answer generation model 170.

Generally, the base language model 210 may comprise a (e.g., pre-trained) autoregressive language model, autoencoding language model, or some combination thereof. The question model tuner 230 may tune or otherwise adapt the base language model 210 to the question generation task using the QA dataset 220, and/or the answer model tuner 250 may tune or otherwise adapt the base language model 210 to the answer generation task using the QA dataset 220. The QA dataset 220 may comprise any suitable representation of any number of QA pairs comprising a question (e.g., in the form of a sentence, a phrase, or any text that prompts an answer) and an answer (e.g., the corresponding response or piece of information that provides a solution, explanation, and/or description in response to the question, and which may take the form of text, numbers, images, tables, and/or other types of responsive data). Example QA datasets include Microsoft Machine Reading Comprehension (MS MARCO), Stanford Question Answering Dataset (SQuAD), OpenBookQA, and NewsQA, to name a few examples. The QA dataset 220 may include a general purpose QA dataset and/or (e.g., manually generated) QA pairs focusing on a particular domain (e.g., which may correspond to the subject matter of the knowledge base of the repository 110 of FIG. 1), which should improve the performance of the tuned models (e.g., the question generation model 140 and/or the answer generation model 170) in that domain.

In some embodiments, the question model tuner 230 may use the QA dataset 220 to tune or otherwise adapt the base language model 210 to the question generation task using any known technique, and/or the answer model tuner 250 may use the QA dataset 220 to tune or otherwise adapt the base language model 210 to the answer generation task using the QA dataset 220 using any known technique. By way of non-limiting example, the question model tuner 230 may use p-tuning to add one or more layers to an input of the base language model 210 to generate some or all of the question generation model 140, and may train the question generation model 140 (e.g., fixing one or more pre-trained layers corresponding to the base language model 210) using the QA dataset 220 to learn corresponding weights (e.g., for the added layer(s)). Additionally or alternatively, the answer model tuner 250 may use p-tuning to add one or more layers to an input of the base language model 210 to generate some or all of the answer generation model 170, and may train the answer generation model 170 (e.g., fixing one or more pre-trained layers corresponding to the base language model 210) using the QA dataset 220 to learn corresponding weights (e.g., for the added layer(s)). This is meant simply as an example, and other training techniques for tuning or otherwise adapting the base language model 210 to the question and/or answer generation tasks are contemplated within the scope of the present disclosure.

As such, and returning to FIG. 1, the question generation model 140 and/or the answer generation model 170 may be used to generate any number of synthetic QA pairs focusing on any desired domain, knowledge base, and/or other use case (whether general purpose or specific). In some embodiments, the training data generation component 190 may associate each synthetic QA pair (e.g., the synthetic question 150 and the synthetic answer 180) with the corresponding unit of text used to source the synthetic QA pair (e.g., the source text 120) to form a (question, answer, context) (Q,A,C) triplet. The synthetic data generation system 100 may repeat the process to generate any number of synthetic QA pairs and/or (Q,A,C) triplets, and the training data generation component 190 may include or otherwise identify a representation of the synthetic QA pairs and/or (Q,A,C) triplets in the synthetic training dataset 195.

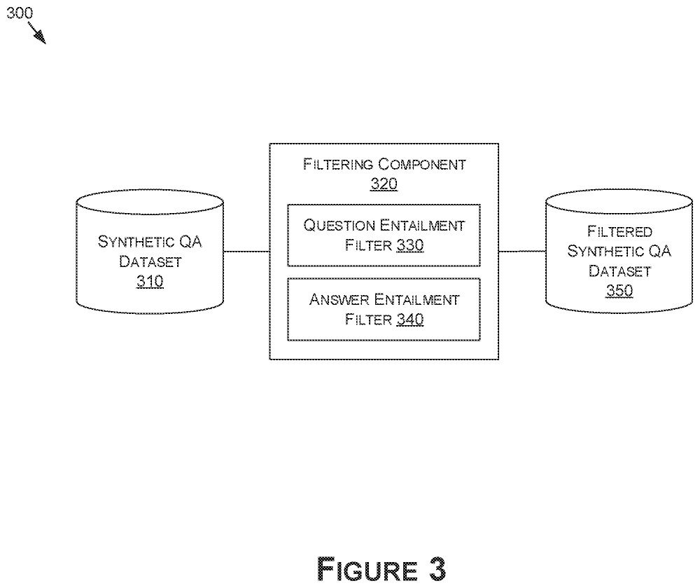

In some embodiments, the training data generation component 190 may apply filtering to filter out low quality, incorrect, and/or non-productive synthetic QA pairs and/or (Q,A,C) triplets that may be a result of or otherwise represent hallucinations. FIG. 3 is a data flow diagram illustrating an example filtering system 300, in accordance with some embodiments of the present disclosure. In the embodiment illustrated in FIG. 3, the filtering system 300 includes a synthetic QA dataset 310 (e.g., comprising synthetic QA pairs and/or (Q,A,C) triplets generated by the synthetic data generation system 100 of FIG. 1), a filtering component 320 comprising a question entailment filter 330 and an answer entailment filter 340, and a filtered synthetic QA dataset 350.

In some embodiments, the question entailment filter 330 may predict whether a synthetic question from a synthetic QA pair and/or (Q,A,C) triplet in the synthetic QA dataset 310 can be answered from the corresponding source unit of text that is represented in the (Q,A,C) triplet or otherwise used to source the synthetic question. For example, the question entailment filter 330 may comprise a language model (e.g., an autoregressive and/or autoencoding language model), which may be tuned or otherwise adapted to the question entailment task. In some embodiments, the question entailment filter 330 may predict whether the synthetic question can be answered from the corresponding source unit of text using zero-, one-, and/or few-shot inference. For example, the filtering component 320 may generate a prompt or other input that represents an instruction to predict whether the synthetic question can be answered from the corresponding source unit of text, and may include a representation of one or more positive and/or negative examples of question entailment in the prompt. A positive example may be represented as a known (e.g., ground truth) question and corresponding text from which the question can be answered, and a negative example may be represented by a known question and text from which the question cannot be answered. Generally, the type of prompt generated and applied may depend on the type of model implemented by the question entailment filter 330. By way of non-limiting example, in some embodiments in which the question entailment filter 330 accepts freeform input text, the filtering component 320 may generate and apply a prompt such as “Here is an example of a question that can be answered from the following paragraph: [question and source text from which the question can be answered]. Here is an example of a question that cannot be answered from the following paragraph: [known question and source text from which the question cannot be answered]. Can the following question be answered by the following paragraph?[synthetic question][source text].” In some embodiments, the filtering component 320 may instruct the question entailment filter 330 to generate an output in a particular format (e.g., yes/no) that the filtering component 320 is configured to understand. These are meant simply as examples, and other prompts may be used, such as hard prompts and/or soft prompts. As such, the filtering component 320 may prompt the question entailment filter 330 to predict whether some or all of the synthetic questions in the synthetic QA dataset 310 can be answered from the corresponding source unit of text, and if the question entailment filter 330 determines that a particular synthetic question cannot, the filtering component 320 may omit the corresponding synthetic QA pair and/or (Q,A,C) triplet from the filtered synthetic QA dataset 350.

Additionally or alternatively, the answer entailment filter 340 may predict whether a synthetic answer from a synthetic QA pair and/or (Q,A,C) triplet in the synthetic QA dataset 310 was actually extracted from the corresponding source unit of text that is represented in the (Q,A,C) triplet or otherwise used to source the synthetic answer. For example, the answer entailment filter 340 may comprise a language model (e.g., an autoregressive and/or autoencoding language model), which may be tuned or otherwise adapted to the answer entailment task. In some embodiments, the answer entailment filter 340 may predict whether the synthetic answer was actually extracted from the corresponding source unit of text using zero-, one-, and/or few-shot inference. For example, the filtering component 320 may generate a prompt or other input that represents an instruction to predict whether the answer question was actually extracted from the corresponding source unit of text, and may include a representation of one or more positive and/or negative examples of answer entailment in the prompt. A positive example may be represented as a known (e.g., ground truth) answer and corresponding text from which the answer was extracted, and a negative example may be represented by a known answer and text from which the answer was not extracted. Generally, the type of prompt generated and applied may depend on the type of model implemented by the answer entailment filter 340. By way of non-limiting example, in some embodiments in which the answer entailment filter 340 accepts freeform input text, the filtering component 320 may generate and apply a prompt such as “Here is an example of an answer that was extracted from the following paragraph: [answer and source text from which the answer was extracted]. Here is an example of an answer that was not extracted from the following paragraph: [answer and source text from which the answer was not extracted]. Was the following answer extracted from the following paragraph?[synthetic answer][source text].” In some embodiments, the filtering component 320 may instruct the answer entailment filter 340 to generate an output in a particular format (e.g., yes/no) the filtering component 320 is configured to understand. These are meant simply as examples, and other prompts may be used, such as hard prompts and/or soft prompts. As such, the filtering component 320 may prompt the answer entailment filter 340 to predict whether some or all of the synthetic answers in the synthetic QA dataset 310 were extracted from the corresponding source unit of text, and if the answer entailment filter 340 determines that a particular synthetic answer was not, the filtering component 320 may omit the corresponding synthetic QA pair and/or (Q,A,C) triplet from the filtered synthetic QA dataset 350.

In some embodiments, the filtering component 320 provides an interface that presents a representation of, or otherwise exposes, the synthetic QA dataset 310 and/or the filtered synthetic QA dataset 350, enabling one or more users operating one or more corresponding devices to review and evaluate the synthetic QA pairs and/or (Q,A,C) triplets to identify and remove synthetic QA pairs and/or (Q,A,C) triplets that represent low quality, incorrect, and/or non-productive data based on one or more pre-defined metrics (e.g., entailment, utility, etc.).

As such, and returning to FIG. 1, in some embodiments, the training data generation component 190 may include the synthetic QA pairs and/or (Q,A,C) triplets from the synthetic QA dataset 350 of FIG. 3 in the synthetic training dataset 195. As such, in some embodiments, the training component 199 may use any known technique to train one or more machine learning models using the synthetic QA pairs and/or (Q,A,C) triplets in the synthetic training dataset 195 may be used. Taking an example machine learning model such as one used in a question answer system, the training component 199 may use the synthetic questions as input training data and the synthetic answers as ground truth training data (e.g., backpropagating a representation of the difference between semantic embeddings of the generated answer and a ground truth synthetic answer).

Taking a retriever model configured to retrieve information from a repository (e.g., the repository 110) as an example, the retriever model may accept a natural language question as its input, encode the question into a corresponding semantic embedding, compare the semantic embedding of the query to embeddings of portions (e.g., chunks) of the repository 110 using some measure of similarity (e.g., cosine similarity), and identify one or more of the chunks having the greatest measure of similarity. As such, the training component 199 may use a synthetic question as input training data, and may use the synthetic answer and/or corresponding source text as corresponding ground truth. For example, the training component 199 may apply the synthetic question to the retriever model, which may retrieve a portion (e.g., chunks) of the repository 110, and the training component 199 may use the corresponding synthetic answer and/or source text as ground truth (e.g., backpropagating a representation of the difference between semantic embeddings of the chunk retrieved by the retrieval model on the one hand, and the ground truth answer and/or source text on the other).

Taking a question answering model that uses a retriever model as an example, a question answering model may take a retrieved portion (e.g., chunk) of the repository 110 (e.g., retrieved by a retrieval model) and generate a corresponding answer from the retrieved portion and the query. As such, the training component 199 may use a synthetic question and the corresponding source text as input training data, and may use the synthetic answer as ground truth (e.g., backpropagating a representation of the difference between semantic embeddings of the generated answer and the synthetic answer).

Additionally or alternatively, depending on the machine learning model(s) to be trained and the type of input and output data the machine learning model(s) are compatible with, in some embodiments, the training data generation component 190 may derive the corresponding input and/or ground truth training data based on the synthetic QA pairs and/or (Q,A,C) triplets in or otherwise identified by the synthetic training dataset 195.

Taking a reranking model as an example, the reranker model may (e.g. use a retriever model to) retrieve a plurality of portions (e.g., chunks) of the repository 110 based on semantic similarity to the query and rerank the retrieved chunks to promote the most relevant chunks to the top of a list of search results. In some embodiments, the training data generation component 190 may designate a synthetic QA triplet as a positive example of a query (the synthetic question) and a ground truth highly re-ranked chunk (e.g., the corresponding synthetic answer and/or source text for the synthetic question), and may designate one or more other synthetic QA triplets (e.g., a synthetic answer and/or the corresponding source text) as negative example(s) of ground truth lower re-ranked chunk(s). For example, the training data generation component 190 may generate an input comprising a representation of: a) a synthetic question from a first synthetic QA triplet, b) the corresponding synthetic answer and/or source text for that synthetic question, and c) one or more synthetic answers and/or source text for one or more other synthetic questions, and the training data generation component 190 may generate a corresponding ground truth output comprising a representation of: a) a ground truth score indicating a positive ranking (e.g., 1) for the synthetic answer and/or source text for the synthetic question in the input, and b) one or more ground truth scores indicating a negative ranking (e.g., 0) for each synthetic answer and/or source text for the other synthetic question(s) that are not part of the input. The training data generation component 190 may repeat the process to generate any number of training data points. As such, the training component 199 may use this generated training data to train the reranking model (e.g., backpropagating the difference between reranking scores generated by the reranking model and ground truth reranking scores). These are just a few examples, and others are contemplated within the scope of the present disclosure.

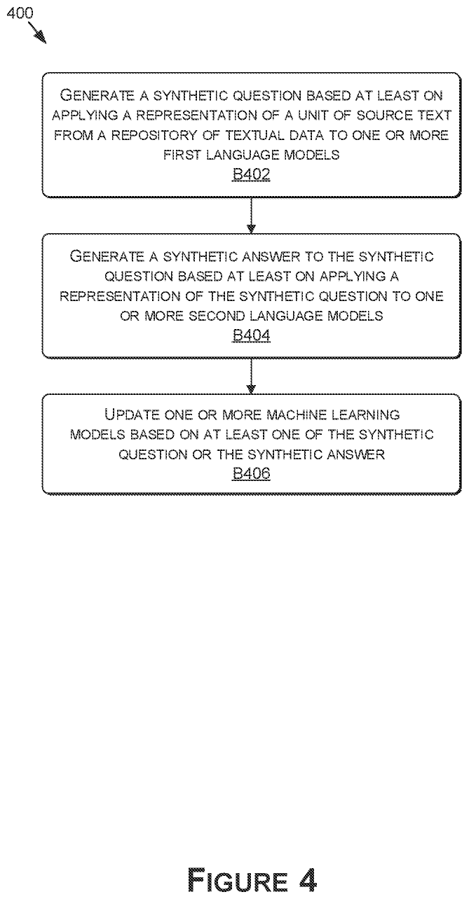

Now referring to FIG. 4, each block of method 400, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, the method 400 is described, by way of example, with respect to the synthetic data generation system 100 of FIG. 1. However, this method may additionally or alternatively be executed by any one system, or any combination of systems, including, but not limited to, those described herein.

FIG. 4 is a flow diagram showing a method 400 for generating a synthetic question and answer pair, in accordance with some embodiments of the present disclosure. The method 400, at block B402, includes generating a synthetic question based at least on applying a representation of a unit of source text from a repository of textual data to one or more first language models. For example, with respect to the synthetic data generation system 100 of FIG. 1, the prompt generator 130 may retrieve a unit of source text from the repository 110, generate a prompt that includes a representation of the unit of source text and an instruction to generate a question based on the unit of source text, and apply the prompt to the question generation model 140, and the question generation model 140 may generate a synthetic question based on the prompt.

The method 400, at block B404, includes generating a synthetic answer to the synthetic question based at least on applying a representation of the synthetic question to one or more second language models. For example, with respect to the synthetic data generation system 100 of FIG. 1, the prompt generator 160 may generate a prompt that includes a representation of the synthetic question (and optionally a corresponding unit of source text retrieved from the repository 110) and an instruction to generate an answer to the synthetic question, the prompt generator 160 may apply the prompt to the answer generation model 170, and the answer generation model 170 may generate a synthetic answer based on the prompt.

The method 400, at block B406, includes updating one or more machine learning models based on at least one of the synthetic question or the synthetic answer. For example, with respect to the synthetic data generation system 100 of FIG. 1, training component 199 may use any known technique to train one or more machine learning models (e.g., those used in question answering systems, information retrieval systems, chatbots and virtual assistants, summarizers, textual entailment systems, machine translation evaluation systems, and/or other types of systems or applications) using the synthetic QA pairs and/or (Q,A,C) triplets in the synthetic training dataset 195 (and/or other training data derived therefrom).

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), systems for performing light transport simulation, systems for performing collaborative content creation for 3D assets, systems implemented at least partially using cloud computing resources, and/or other types of systems.

### Example Computing Device

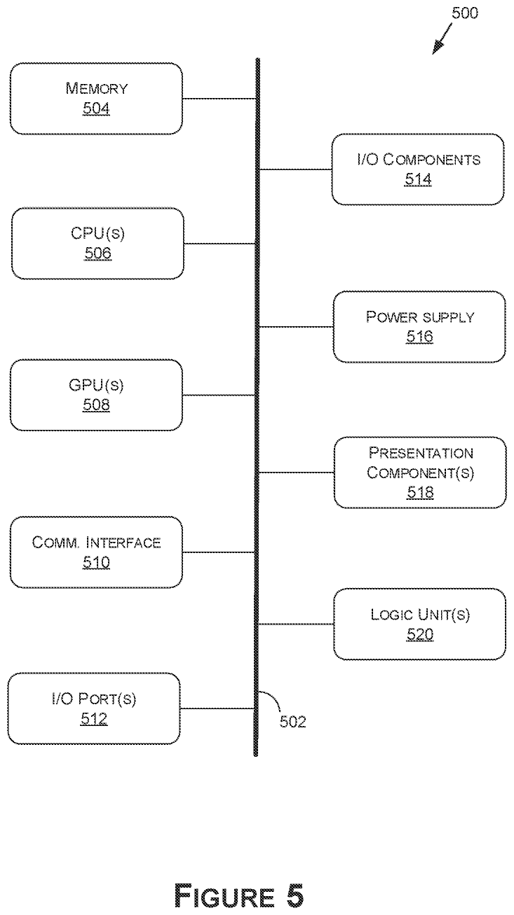

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

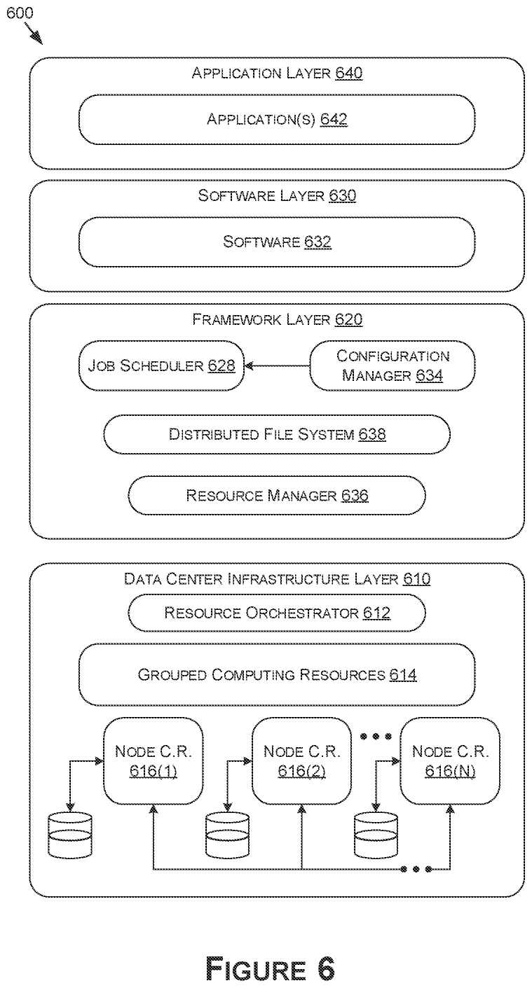

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more processing units to:
generate a synthetic question based at least on applying a representation of a unit of source text from a repository of textual data to one or more first language models;
generate a synthetic answer to the synthetic question based at least on applying a representation of the synthetic question to one or more second language models; and
update one or more parameters of one or more machine learning models based on at least one of the synthetic question or the synthetic answer.

2. The processor of claim 1, wherein the one or more processing units are further to generate the synthetic answer based at least on applying the representation of the synthetic question and the unit of source text from the repository to the one or more second language models.

3. The processor of claim 1, wherein the one or more processing units are further to determine to exclude the synthetic question and the synthetic answer from a dataset based at least on using one or more third language models tuned for question entailment to predict that the synthetic question cannot be answered from the unit of source text.

4. The processor of claim 1, wherein the one or more processing units are further to determine to exclude the synthetic question and the synthetic answer from a dataset based at least on using one or more third language models tuned for answer entailment to predict that the synthetic answer was not extracted from the unit of source text.

5. The processor of claim 1, wherein the one or more processing units are further to determine, using one or more third language models tuned for at least one of question entailment or answer entailment, that at least one of the synthetic question or the synthetic answer represents a hallucination.

6. The processor of claim 1, wherein the one or more processing units are further to generate the one or more first language models based at least on tuning a base language model to tailor the base language model to a question generation task.

7. The processor of claim 1, wherein the one or more processing units are further to generate the one or more second language models based at least on tuning a base language model to tailor the base language model to an answer generation task.

8. The processor of claim 1, wherein the one or more processing units are further to generate at least one of the one or more first language models or the one or more second language models based at least on tuning using one or more question-answer pairs in a common domain as the unit of source text for the synthetic question.

9. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

10. A system comprising one or more processing units to generate a synthetic question based at least on applying a representation of one or more sequences of source text from a repository to one or more first language models, and generate a synthetic answer to the synthetic question based at least on applying a representation of the synthetic question to one or more second language models.

11. The system of claim 10, wherein the one or more processing units are further to generate the synthetic answer based at least on applying the representation of the synthetic question and the one or more sequences of source text from the repository to the one or more second language models.

12. The system of claim 10, wherein the one or more processing units are further to determine to exclude the synthetic question and the synthetic answer from a dataset based at least on using one or more third language models tuned for question entailment to predict that the synthetic question cannot be answered from the one or more sequences of source text.

13. The system of claim 10, wherein the one or more processing units are further to determine to exclude the synthetic question and the synthetic answer from a dataset based at least on using one or more third language models tuned for answer entailment to predict that the synthetic answer was not extracted from the one or more sequences of source text.

14. The system of claim 10, wherein the one or more processing units are further to determine, using one or more third language models tuned for at least one of question entailment or answer entailment, that at least one of the synthetic question or the synthetic answer represents a hallucination.

15. The system of claim 10, wherein the one or more processing units are further to generate the one or more first language models based at least on tuning a base language model to tailor the base language model to a question generation task.

16. The system of claim 10, wherein the one or more processing units are further to generate the one or more second language models based at least on tuning a base language model to tailor the base language model to an answer generation task.

17. The system of claim 10, wherein the one or more processing units are further to generate at least one of the one or more first language models or the one or more second language models based at least on tuning using one or more question-answer pairs in a common domain as the one or more sequences of source text for the synthetic question.

18. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

19. A method comprising:
generate a synthetic question based at least on applying a representation of a sequence of source text from a repository to one or more first language models;
generate a synthetic answer to the synthetic question based at least on applying a representation of the synthetic question to one or more second language models; and
update one or more machine learning models based on at least one of the synthetic question or the synthetic answer.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.
